(19) United States
(12) Patent Application Publication
(10) Pub. No.: US 2008/0277262 A1
(43) Pub. Date: Nov. 13, 2008

(54) SYSTEM AND METHOD FOR WASTEWATER REDUCTION AND FRESHWATER GENERATION

(75) Inventor: James Jeffrey Harris, (US)

Correspondence Address: DUBOIS, BRYANT, CAMPBELL & SCHWARTZ, LLP, 700 LAVACA STREET, SUITE 1300, AUSTIN, TX, 78701, US

(73) Assignee: INTEVRAS TECHNOLOGIES, LLC.

(21) Appl. No.: 12/119,460

(22) Filed: May 12, 2008

Related U.S. Application Data
(60) Provisional application No. 60/917,468, filed on May 11, 2007.

(51) Int. Cl. C02F 1/04

(52) U.S. Cl. 203/10; 202/94

(57) ABSTRACT

A process whereby freshwater is generated and wastewater is eliminated through the employ of waste combustion gas; wherein combustion gas is cooled below dewpoint, via the effects of a wastewater fed evaporative cooler, resulting in the combined benefits of freshwater generation from the combustion gas and evaporative reduction of the wastewater.

### CROSS-REFERENCE TO RELATED APPLICATIONS

This non-provisional application claims priority based upon prior U.S. Provisional Patent Application Ser. No. 60/917,468 filed May 11, 2007 in the name of James Jeffery Harris, entitled “A Process for Freshwater Generation and Wastewater Reduction,” the disclosure of which is incorporated herein by reference.

### BACKGROUND OF THE INVENTION

The present invention is related generally to wastewater reduction and freshwater generation and, more particularly, to a process wherein the cooling effects of evaporative reduction of useless wastewater purveys condensation and generation of freshwater from combustion combustion gas.

Water is a resource for life and industry. Fresh water is essential for all plant and animal life. Similarly, fresh water is the lifeblood of many, if not most, industries because of water's unique fluid, chemical and physical properties. In contrast, wastewater, which is often generated as a byproduct of biological and industrial activities, can be essentially useless; it's quality running the gamut from being relatively benign and useful for other activities to being toxic, hazardous and otherwise useless. Disposal of the poorer quality, useless wastewater instills a liability and financial burden upon industry, society and the environment.

Wastewater elimination has evolved from simple environmental dumping to many and varied treatment and/or disposal processes. Treatment processes have generally focused on conversion of a useless wastewater into a useful freshwater or a less toxic or hazardous wastewater which is amenable to relatively benign eco-system absorption. Often the treatment processes had focused on generation of a reusable, high quality freshwater product a reduced and concentrated wastewater product of which remains to be disposed.

Wastewater treatment processes of the prior-art trend into four primary categories; 1) bioreaction, 2) filtration, 3) distillation and 4) chemical treatment. Bioreaction processes employ biologically active fauna and flora to digest and eliminate wastewater contaminants. The reader is addressed to U.S. Pat. Nos. 4,931,183 (Klein), 7,314,561 (Jensen), 7,279,104 (Keeton), 7,144,509 (Boyd) and 6,428,691 (Wofford) as examples of the bioremediation appliances of the prior-art. An inherent disadvantage of existing bioremediation processes and apparatus is the necessity that the wastewater be conducive to supporting living fauna and flora. Many industrial wastewaters contain materials fatal to organisms, rendering the bioremediation approach ineffective. In such situations useless wastewater volumes are not reduced and useful freshwater volumes are not generated.

Filtration processes of the prior art employ mechanical and molecular sieve-type means to remove solid contaminants from the wastewater. Filtration processes address several ranges of solids removal foci, dependent upon the contaminating solids size. These processes range from mesh type of catchment screens for large particle removal to membrane apparatus for dissolved solids removal. The reader is referred to the following US patents addressing examples of the prior art; Pat. Nos. 6,162,361 (Adiga), 6,080,317 (Wagner), 5,350,526 (Sharkey), 4,309,292 (Stannard), 5,006,234 (Menon) and 4,909,934 (Brown). An inherent disadvantage of the prior-art is an inability to address high solids content concentrations, especially high dissolved solids concentrations. Fresh water generation and wastewater reduction at high dissolved solids concentration are suppressed by prohibitively high osmotic pressure requirements. Further, at high dissolved solids concentrations, plugging and scaling problems associated with common mineral precipitation, generally render the prior-art inoperable.

Distillation processes of the prior-art employ heat to extract water vapor from wastewater imbuing a reduction in the wastewater volume. Cooling and condensing the extracted water vapor then affords a useful, freshwater product. The reader is referred to the following US patents addressing examples of the prior art; Pat. Nos. 6,391,162 (Kamiya), 4,344,826 (Smith), 5,381,742 (Linton) and 5,772,843 (Rhodes). Two primary disadvantages are inherent to this prior-art. One is the requirement for thermal energy, which, in many situations, is prohibitively expensive. The second disadvantage is the inability of the prior-art to operate at high dissolved solids levels. Because of heat exchanger scaling, the prior-art cannot effectively operate to reduce wastewater volumes and generate freshwater from high dissolved solids level wastewater.

Chemical treatment of wastewater employs the addition of chemicals to sterilize, clarify or enhance the quality of the wastewater. These treatments aim at renovation of substantially all of a wastewater volume for reuse. The following US patents address examples of this prior art; Pat. Nos. 5,770,092 (Sharir), 5,647,977 (Arnaud), 7,014,767 (Jensen) and 6,767,472 (Miller). A primary disadvantages of this prior art is an inability to address dissolved solids. Waters, rendered useless because of high dissolved solids concentration, are not amenable to treatment by these efforts of the prior-art.

The foregoing discussion focuses on efforts of the prior-art to provide means to generate a useful water product from a useless wastewater source. The affect provides both a useful water source as well as reducing a wastewater burden. The prior-art also demonstrates processes wherein means to reduce the wastewater volumes only are addressed, primarily through thermally driven boiling and evaporative processes. The reader is referenced to the inventors U.S. Pat. Nos. 6,468,389, 6,119,458 and 5,958,110 as well as the following US patents by others Pat. Nos. 6,200,428 (Vankouenberg), 5,792,313 (Johansson), 5,772,843 (Rhodes), 5,582,680 (Vankouenberg) and 5,240,560 (Gregory). These examples of the prior-art do not address generation of freshwater as a goal.

Therefore, in light of the prior art, it can be appreciated that there is a significant need to address both the generation of useful freshwater as well as the reduction of wastewater in those prevalent situations where the wastewater quality is very poor. The present invention provides these and other advantages, as will be apparent from the following detailed description and accompanying figures.

### BRIEF SUMMARY OF THE INVENTION

In accordance with the present invention, a process transfers heat from a combustion gas to reduce wastewater volumes and to generate freshwater. In a preferred embodiment of the present invention, a means of transferring heat from a combustion gas to a wastewater is employed to condense water vapor from the combustion gas and to reduce wastewater volume through evaporation. In a preferred embodiment of the present invention, wastewater is reduced to either a concentrated liquid or a solid and generated freshwater is treated for outside process use.

Those skilled in the art will clearly recognize from FIGS. 1-7, the substantial benefits afforded by the invention. Providing a usable means to generate both freshwater while eliminating wastewater, through the employ of an otherwise wasted freshwater source provided by the water vapor combustion products entrained within the combustion gas. The knowledgeable reader will further note that since the freshwater source is unrelated to the wastewater source, the quality of the wastewater is immaterial pertaining to freshwater generation. In accordance with the present invention, a unique and innovative means for inexpensive exploitation of a prevalent, albeit previously considered useless, waste combustion gas as a thermal source induces evaporative reduction of wastewater while further providing a source of freshwater generation.

The physical features and configuration of a preferred embodiment of the present invention permit adaptation and utilization of existing combustion gas sources. This advantage offers the hitherto unavailable capability for reduction of wastewater and generation of freshwater from existing, operating locales. In accordance with the present invention, the evaporative reduction of wastewater is employed to cool an otherwise wasted combustion gas from an unrelated, useful thermal process to a temperature below the dewpoint temperature of the gas; effecting the condensation of combustion generated water vapor from the combustion gas into a liquid water source.

Advantages of a preferred embodiment of the present invention over the prior art include, but are not limited to, the following: reduction of environmental liabilities, generation of freshwater, low operating costs, low chemical requirements, high reliability, a high capacity to handle wastewater quality changes, elimination of many pumps, valves and associated controls, a saving of electrical power, savings of thermal energy, and an elimination of the potential of wastewater contaminant carryover into the freshwater product.

In accordance with the present invention, the freshwater product is not sourced from the wastewater so diligent water chemistry monitoring and chemical dosing is not required. This is in contrast to the prior art, wherein water chemistry is crucial for successful generation of freshwater. Accordingly, in contrast to the prior art, the employment of qualified personnel skilled in the science of water chemistry, and their corresponding expense is not required. In a preferred embodiment of the present invention, an inexpensive and reliable means for both reducing wastewater and generating freshwater is provided.

A problem inherent in the prior-art is maintenance of sterility to eliminate wastewater fouling and freshwater contamination. Biological controls such as, but not limited to; chemical biocides, chlorination, bromination, ozonation and ultraviolet treatment are employed by the prior-art to avert biological infection of both the wastewater and the freshwater. A further advantage of a preferred embodiment of the present invention over the prior-art is the natural control provided against biological infestation of both the reducing wastewater and the freshwater product. A preferred embodiment of the present invention operates successfully with sufficiently high dissolved solids concentrations in the wastewater to insure sterility, since the wastewater is independent of the source of the freshwater. Further, since the source of the freshwater product is combustion, the chemical reaction generated water vapor and associated condensate is sterile. A preferred embodiment of the present invention affords natural sterility without the need for biocides or sterilization treatment.

A further liability inherent to the prior art is the residual volume of wastewater following freshwater generation. The handling and disposal of this residual wastewater represents both an expense and environmental liability. A preferred embodiment of the present invention is not limited by the water quality of the wastewater. Accordingly, the wastewater can be concentrated and reduced to a much smaller volume than is possible with the prior-art, thereby minimizing both the expense and liabilities associated with disposal.

A significant disadvantage of thermal processes of the prior-art is the requirement for high grade thermal or electrical energy to engender operations. The operating expenses associated with consumption of such high grade energy sources is burdensome and can indeed be prohibitive for many applications. In contrast to the prior-art, a preferred embodiment of the present invention employs low grade, otherwise wasted, often existing, heat sources for operation. This opportune characteristic of a preferred embodiment of the present invention engenders a substantial operating expense advantage over the prior art. Indeed the employ of waste heat purveys the opportunity for a preferred embodiment of the present invention to operate in many locations not financially feasible with the prior art. Further, applications of the prior art requiring high grade, combustion generated thermal energy, carry additional burdens and liabilities associated with air pollution emissions. Often such emissions carry requirements for additional permitting and associated expenses, liabilities, operational delays, routine testing and recertification, operational curtailments as well as the potential for non-approval in many locales.

Further features and advantages of the present invention will be apparent from the following detailed description and accompanying figures.

### BRIEF DESCRIPTION OF THE DRAWINGS

FIG. 1 is a process diagram illustrative of a preferred embodiment of the present invention wherein a coolant is employed to transfer heat from a combustion gas to a concentrating wastewater evaporator.

FIG. 2 is a process diagram illustrative of a preferred embodiment of the present invention wherein a coolant is employed to transfer heat from a combustion gas to a crystalizing wastewater evaporator.

FIG. 3 is a process diagram illustrative of a preferred embodiment of the present invention wherein freshwater is employed to transfer heat from a combustion gas to a concentrating wastewater evaporator.

FIG. 4 is a process diagram illustrative of a preferred embodiment of the present invention wherein a coolant is employed to transfer heat from a combustion gas to a crystalizing wastewater evaporator.

FIG. 5 is a process diagram illustrative of a preferred embodiment of the present invention wherein both a coolant and fresh water are employed to transfer heat from a combustion gas to a concentrating wastewater evaporator.

FIG. 6 is a process diagram illustrative of a preferred embodiment of the present invention wherein both a coolant and fresh water are employed to transfer heat from a combustion gas to a crystallizing wastewater evaporator.

FIG. 7 is a process diagram illustrative of a preferred embodiment of the present invention wherein both a coolant and fresh water are employed to transfer heat from a combustion gas to a crystallizing wastewater evaporator and the freshwater coolant is treated.

### DETAILED DESCRIPTION

The following numerals are used as references in the figures: Wastewater evaporator 2; Combustion gas contactor 4; Wastewater evaporator heat exchanger 6; Wastewater Inlet 8; Concentrate/reduced water outlet 10; Solids and crystals outlet 12; Cooling air inlet 14; Cooling air outlet 16; Cold coolant 18; Warm coolant 20; Cold freshwater coolant 22; Warm freshwater 24; Fresh water outlet 26; Hot combustion gas inlet 28; Cool combustion gas outlet 30; Warm untreated freshwater 32; Freshwater treatment 34; and Treated freshwater 36.

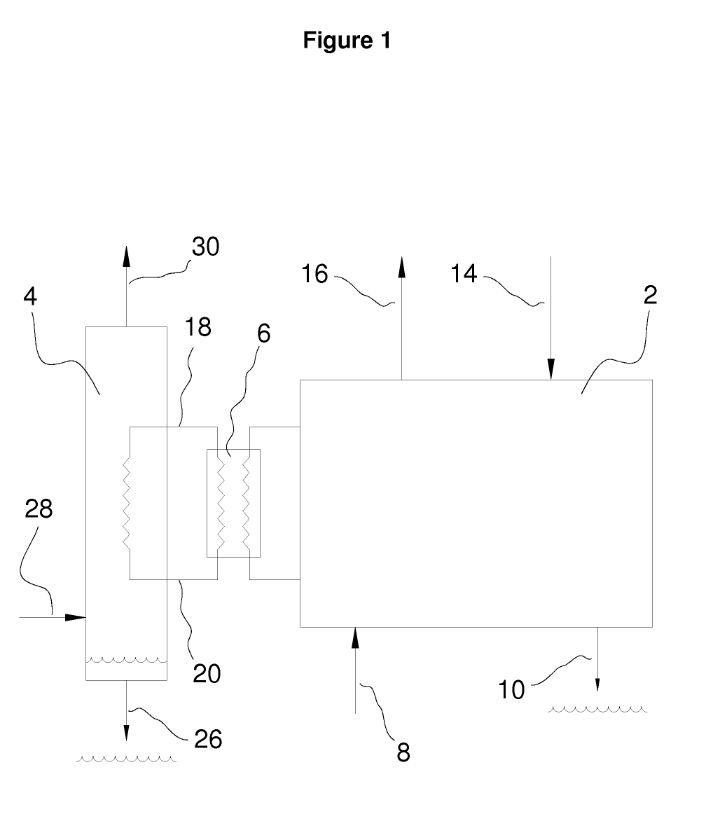

Reference is now made to FIG. 1 which is a process diagram of a preferred embodiment of the present invention wherein a cold coolant 18 is circulated between a wastewater evaporator heat exchanger 6 and a combustion gas contactor 4. This coolant cools the incoming combustion gas 28 via an indirect contact heat exchange process internal to the combustion gas contactor. The combustion gas, sometimes also referred to as a flue gas in the art, is cooled below dewpoint prior to being discharged 30. Freshwater is condensed from the combustion gas in the combustion gas contactor and is discharged thereof 26. Heat extracted from the combustion gas is conveyed, via warm coolant 20, to the wastewater evaporator heat exchanger 6, which conveys the heat into a wastewater evaporator 2. This heat is transferred, via evaporative cooling, into the cooling air 14. Warm, humid air 16 exits the wastewater evaporator carrying heat and wastewater sourced water vapor from the invention. Extraction of water vapor from the wastewater generates a reduced volume of concentrated liquid. This concentrate is discharged from the wastewater evaporator 10.

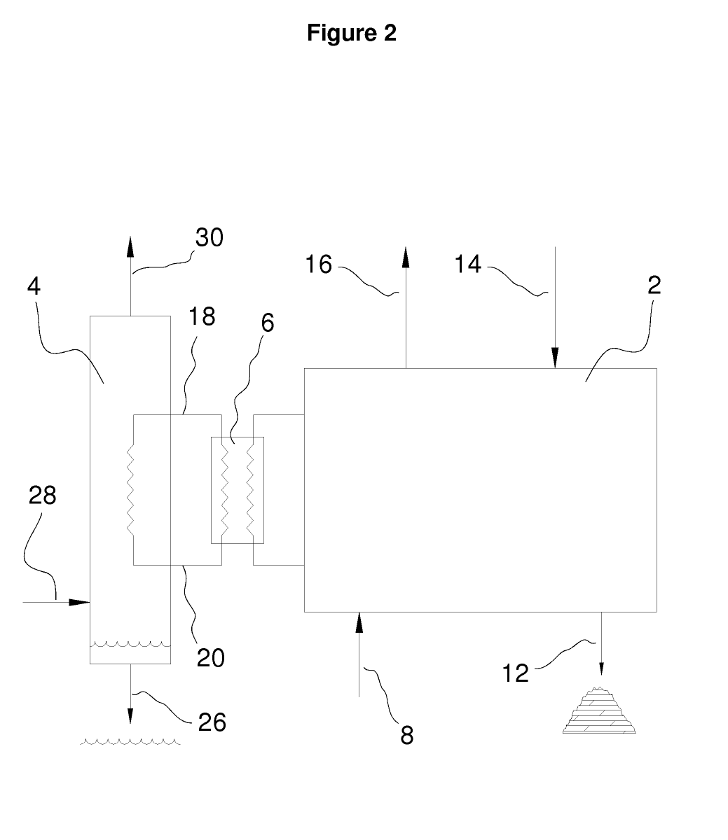

Reference is now made to FIG. 2 which is a process diagram of a preferred embodiment of the present invention wherein a cold coolant 18 is circulated between a wastewater evaporator heat exchanger 6 and a combustion gas contactor 4. This coolant cools the incoming combustion gas 28 via an indirect contact heat exchange process internal to the combustion gas contactor. The combustion gas is cooled below dewpoint prior to being discharged 30. Freshwater is condensed from the combustion gas in the combustion gas contactor and discharged thereof 26. Heat extracted from the combustion gas is conveyed, via warm coolant 20, to the wastewater evaporator heat exchanger 6, which conveys the heat into a wastewater evaporator 2. This heat is transferred via evaporative cooling into the cooling air 14. Warm, humid air 16 exits the wastewater evaporator carrying heat and wastewater sourced water vapor from the invention. Extraction of water vapor from the wastewater concentrates the wastewater to saturation. Crystals and solids separate from the wastewater concentrate and are discharged 12 from the wastewater evaporator.

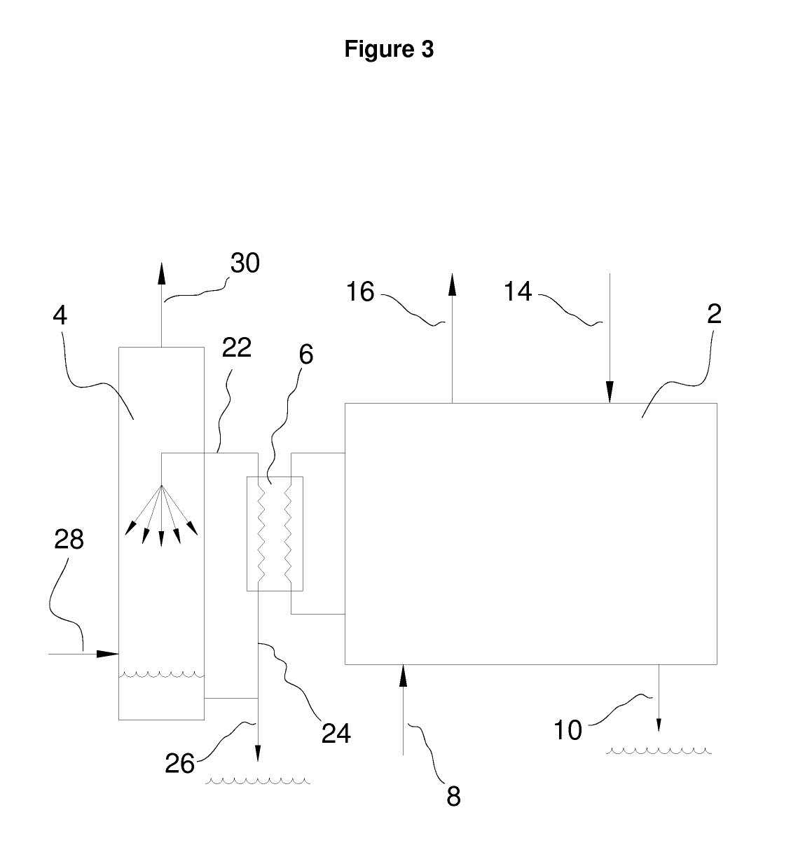

Reference is now made to FIG. 3 which is a process diagram of a preferred embodiment of the present invention wherein a cold freshwater coolant 22 is circulated between a wastewater evaporator heat exchanger 6 and a combustion gas contactor 4. This coolant cools the incoming combustion gas 28 via a direct contact heat exchange process internal to the combustion gas contactor. The combustion gas is cooled below dewpoint prior to being discharged 30. Combustion generated freshwater condenses from the combustion gas into the freshwater coolant in the combustion gas contactor and is discharged as excess volume 26. Heat extracted from the combustion gas is conveyed, via the remaining warm freshwater 24, to the wastewater evaporator heat exchanger 6, which conveys the heat into a wastewater evaporator 2. This heat is transferred, via evaporative cooling, into the cooling air 14. Warm, humid air 16 exits the wastewater evaporator carrying heat and wastewater sourced water vapor from the invention. Extraction of water vapor from the wastewater generates a reduced volume of concentrated liquid. This concentrate is discharged from the wastewater evaporator 10.

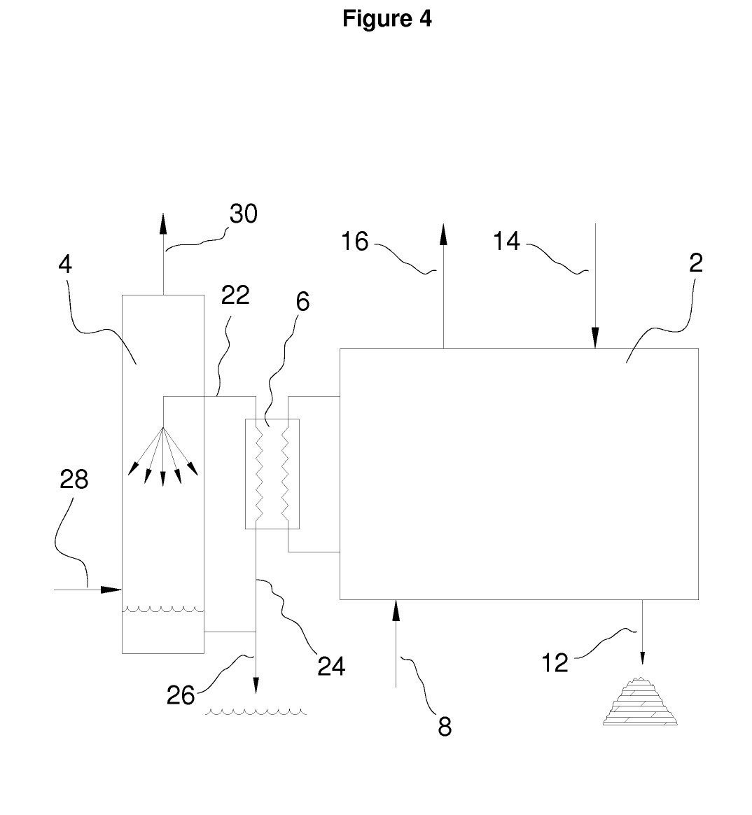

Reference is now made to FIG. 4 which is a process diagram of an embodiment wherein a cold freshwater coolant 22 is circulated between a wastewater evaporator heat exchanger 6 and a combustion gas contactor 4. This coolant cools the incoming combustion gas 28 via a direct contact heat exchange process internal to the combustion gas contactor. The combustion gas is cooled below dewpoint prior to being discharged 30. Combustion generated freshwater condenses from the combustion gas into the freshwater coolant in the combustion gas contactor and is discharged as excess volume 26. Heat extracted from the combustion gas is conveyed, via the remaining warm freshwater 24, to the wastewater evaporator heat exchanger 6, which conveys the heat into a wastewater evaporator 2. This heat is transferred, via evaporative cooling, into the cooling air 14. Warm, humid air 16 exits the wastewater evaporator carrying heat and wastewater sourced water vapor from the invention. Extraction of water vapor from the wastewater concentrates the wastewater to saturation. Crystals and solids separate from the wastewater concentrate and are discharged 12 from the wastewater evaporator.

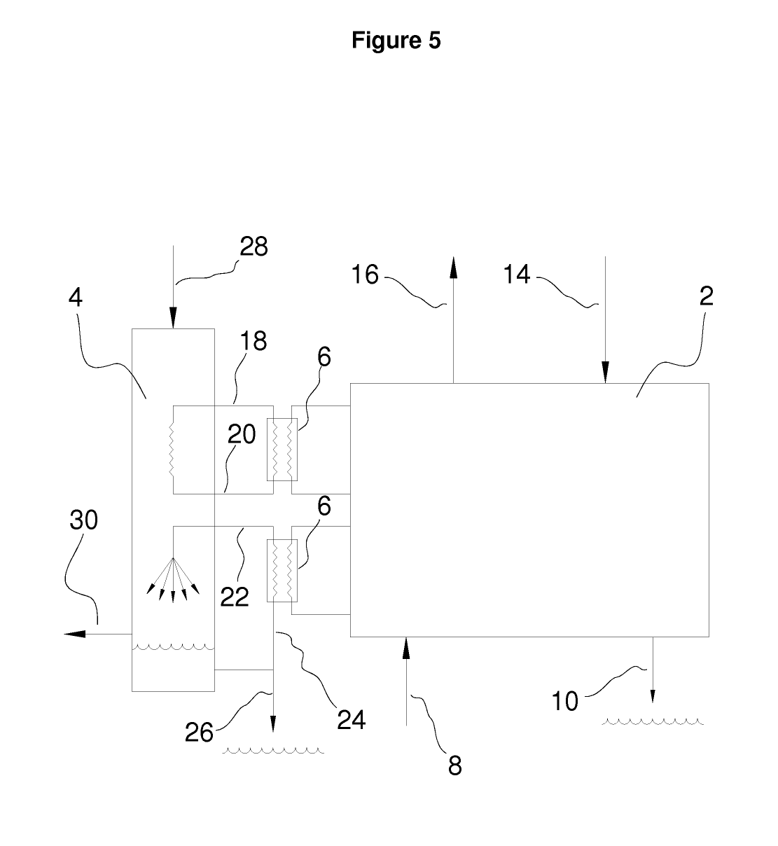

Reference is now made to FIG. 5 which is a process diagram of a preferred embodiment of the present invention wherein a combustion gas is cooled below dewpoint in a multi-step process. In this embodiment, cold coolant 18 is circulated between a wastewater evaporator heat exchanger 6 and a combustion gas contactor 4. This coolant cools the incoming combustion gas 28 via an indirect contact heat exchange process internal to the combustion gas contactor. The combustion gas is cooled but remains above dewpoint. Heat extracted from the combustion gas is conveyed, via warm coolant 20, to the wastewater evaporator heat exchanger 6, which conveys the heat into a wastewater evaporator 2. This heat is transferred, via evaporative cooling, into the cooling air 14. Warm, humid air 16 exits the wastewater evaporator carrying heat and wastewater sourced water vapor from the invention.

The partially cooled combustion gas enters a second stage of cooling wherein a cold freshwater coolant 22 is circulated between a wastewater evaporator heat exchanger 6 and a combustion gas contactor 4. This coolant further cools the combustion gas via a direct contact heat exchange process. The combustion gas is cooled below dewpoint prior to being discharged 30. Combustion generated freshwater condenses from the combustion gas into the freshwater coolant in the combustion gas contactor and is discharged as excess volume 26. Heat extracted from the combustion gas is conveyed, via the remaining warm freshwater 24, to the wastewater evaporator heat exchanger 6, which conveys the heat into a wastewater evaporator 2. This heat is transferred, via evaporative cooling, into the cooling air 14. Warm, humid air 16 exits the wastewater evaporator carrying heat and wastewater sourced water vapor from the invention. Extraction of water vapor from the wastewater generates a reduced volume of concentrated liquid. This concentrate is discharged from the wastewater evaporator 10.

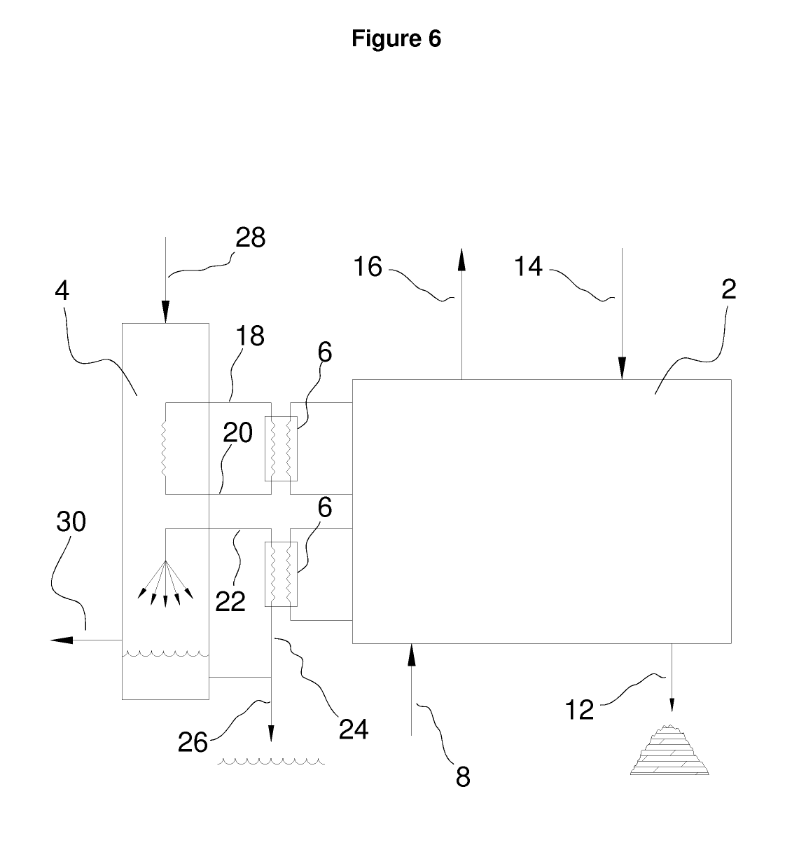

Reference is now made to FIG. 6 which is a process diagram of a preferred embodiment of the present invention wherein a combustion gas is cooled below dewpoint in a multi-step process. In this embodiment, cold coolant 18 is circulated between a wastewater evaporator heat exchanger 6 and a combustion gas contactor 4. This coolant cools the incoming combustion gas 28 via an indirect contact heat exchange process internal to the combustion gas contactor. The combustion gas is cooled but remains above dewpoint. Heat extracted from the combustion gas is conveyed, via warm coolant 20, to the wastewater evaporator heat exchanger 6, which conveys the heat into a wastewater evaporator 2. This heat is transferred, via evaporative cooling, into the cooling air 14. Warm, humid air 16 exits the wastewater evaporator carrying heat and wastewater sourced water vapor from the invention.

The partially cooled combustion gas enters a second stage of cooling wherein a cold freshwater coolant 22 is circulated between a wastewater evaporator heat exchanger 6 and a combustion gas contactor 4. This coolant further cools the combustion gas via a direct contact heat exchange process. The combustion gas is cooled below dewpoint prior to being discharged 30. Combustion generated freshwater condenses from the combustion gas into the freshwater coolant in the combustion gas contactor and is discharged as excess volume 26. Heat extracted from the combustion gas is conveyed, via the remaining warm freshwater 24, to the wastewater evaporator heat exchanger 6, which conveys the heat into a wastewater evaporator 2. This heat is transferred, via evaporative cooling, into the cooling air 14. Warm, humid air 16 exits the wastewater evaporator carrying heat and wastewater sourced water vapor from the invention. Extraction of water vapor from the wastewater concentrates the wastewater to saturation. Crystals and solids separate from the wastewater concentrate and are discharged 12 from the wastewater evaporator.

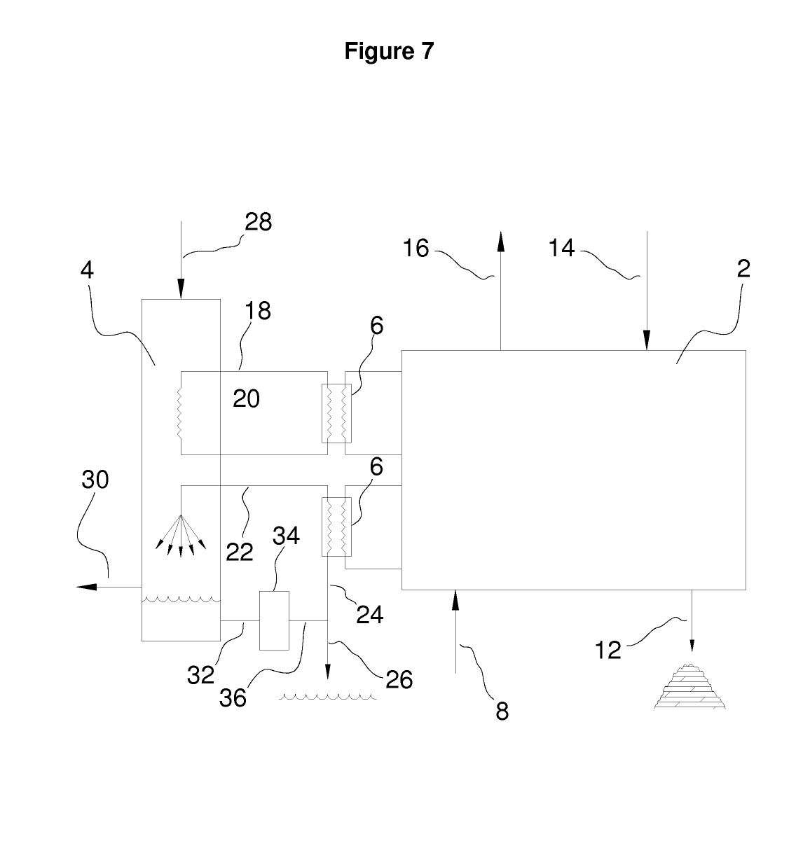

Reference is now made to FIG. 7 which is a process diagram of a preferred embodiment of the present invention wherein a combustion gas is cooled below dewpoint in a multi-step process. In this embodiment, cold coolant 18 is circulated between a wastewater evaporator heat exchanger 6 and a combustion gas contactor 4. This coolant cools the incoming combustion gas 28 via an indirect contact heat exchange process internal to the combustion gas contactor. The combustion gas is cooled but remains above dewpoint. Heat extracted from the combustion gas is conveyed, via warm coolant 20, to the wastewater evaporator heat exchanger 6, which conveys the heat into a wastewater evaporator 2. This heat is transferred, via evaporative cooling, into the cooling air 14. Warm, humid air 16 exits the wastewater evaporator carrying heat and wastewater sourced water vapor from the invention.

The partially cooled combustion gas enters a second stage of cooling wherein a cold freshwater coolant 22 is circulated between a wastewater evaporator heat exchanger 6 and a combustion gas contactor 4. This coolant further cools the combustion gas via a direct contact heat exchange process. The combustion gas is cooled below dewpoint prior to being discharged 30. Combustion generated freshwater condenses from the combustion gas into the freshwater coolant in the combustion gas contactor. This warmed freshwater 32 is treated for quality requirements 34. The warm, treated freshwater 36 and split with excess volume being discharged 26. Heat extracted from the combustion gas is conveyed, via the remaining warm freshwater 24, to the wastewater evaporator heat exchanger 6, which conveys the heat into a wastewater evaporator 2. This heat is transferred, via evaporative cooling, into the cooling air 14. Warm, humid air 16 exits the wastewater evaporator carrying heat and wastewater sourced water vapor from the invention. Extraction of water vapor from the wastewater concentrates the wastewater to saturation. Crystals and solids separate from the wastewater concentrate and are discharged 12 from the wastewater evaporator.

In accordance with an embodiment of the present invention, a simple, reliable, economic and environmentally sound means to improve upon the prior-art processes for extracting freshwater from wastewater, as well as for reducing the volume of wastewater, is provided. In accordance with an embodiment of the present invention, the disadvantages associated the prior art are eliminated.

In accordance with an embodiment of the present invention and in contrast to the prior art, the use of high grade energy is not required; thereby providing an improved means to generate freshwater and eliminate wastewater without the expense and liabilities associated with electrical, fuel or steam consumption.

In accordance with an embodiment of the present invention and in contrast to the prior art, the additional combustion of fuel is not required; thereby providing an improved means to generate freshwater and eliminate wastewater without the permitting, expense and environmental liabilities associated with combustion.

In accordance with an embodiment of the present invention, existing combustion gas sources for freshwater generation and wastewater reduction can be employed; thereby eliminating new site requirements and expenses due to permitting, egress and ingress, fuel or gas pipelining or other new site issues.

In accordance with an embodiment of the present invention, otherwise wasted resources to generate freshwater and reduce wastewater can be taken advantage of; in contrast to the prior-art which must employ project specific resources.

In accordance with an embodiment of the present invention, freshwater quality is independent of wastewater quality, purveying the ability to process wastewaters of which the prior-art is incapable.

In accordance with an embodiment of the present invention, since freshwater quality is independent of wastewater quality, freshwater quality is independent of variations in wastewater constituents. Such variations present a problem that is prevalent in the prior-art.

In accordance with an embodiment of the present invention, freshwater from a source other than the wastewater is generated, eliminating any potential for contaminant carryover from the wastewater into the generated freshwater. Such potential cross contamination is an inherent liability prevalent in the prior-art.

In accordance with an embodiment of the present invention, no environmental liabilities are purveyed, in contrast to much of the prior-art which often generates difficult and sometimes hazardous waste products.

In accordance with an embodiment of the present invention, biological contamination is not a concern and, accordingly, the employ of hazardous biocides and other chemicals for maintenance of sterility is unnecessary.

In accordance with an embodiment of the present invention, the employ and maintenance of high skilled staffing is unnecessary.

In accordance with an embodiment of the present invention, freshwater is generated and wastewater is reduced to a minimum volume as concentrate or solids; thereby eliminating the wastewater handling and disposal expenses and liabilities which plaque the prior-art.

While the foregoing discussions specify the many advantages inherent to the invention these do not constitute the full scope of advantages. There are many advantages beyond those defined herein. In a similar manner, the preferred and additional embodiments described in the foregoing, are certainly not the only embodiment possible. In addition to the many possible combinations of the foregoing embodiments, other embodiments are possible. Some, though certainly not all, examples of other embodiments and advantages are as follows: (i) Chemicals can be added to the freshwater coolant to extract valuable or hazardous materials from the combustion gas stream; (ii) Chemicals can be added to the freshwater coolant to extract valuable or hazardous materials from the combustion gas stream. This fluid could then be conveyed as feed water to the wastewater evaporator for concentration or solidification; (iii) The warm, humid air discharged from the wastewater evaporator can be further cooled to generate additional fresh water; (iv) Chemicals can be added to the combustion gas to reduce air missions. Residual or byproducts from this addition can be collected in the freshwater coolant; and (v) Chemicals can be added to the combustion fuel for carryover into the combustion gas to reduce air missions or to have other beneficial effects. Residual or byproducts from this fuel addition can be collected in the freshwater coolant.

It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It will be appreciated by persons skilled in the art that the present invention is not limited by what has been particularly shown and described hereinabove.

What is claimed is:

1. A system for reducing wastewater and generating freshwater comprising:
a wastewater evaporator;
a combustion gas contactor;
a heat exchanger wherein said heat exchanger transfers heat from a combustion gas within said combustion gas contactor to a wastewater within said wastewater evaporator; and wherein said heat transfer cools said combustion gas to a temperature below the temperature at which freshwater begins to condense from said combustion gas.

2. The system of claim 1 wherein said heat transfer assists at least partial evaporation of said wastewater within said wastewater evaporator.

3. The system of claim 1 wherein said cooling condenses freshwater from said combustion gas and said combustion gas contactor discharges said freshwater.

4. The system of claim 1 wherein said heat transfer involves circulating a coolant between said heat exchanger and said combustion gas contactor.

5. The system of claim 2 wherein said at least partial evaporation of said wastewater reduces the volume of said wastewater within said wastewater evaporator.

6. The system of claim 2 wherein said wastewater evaporator discharges a reduced liquid generated by said at least partial evaporation of said wastewater.

7. The system of claim 2 wherein said wastewater evaporator discharges a solid material generated by said at least partial evaporation of said wastewater.

8. The system of claim 1 wherein a freshwater coolant circulates between said heat exchanger and said combustion gas contactor, wherein said cooling condenses freshwater from said combustion gas, wherein said freshwater combines with said freshwater coolant, and excess volumes of said combined freshwater and freshwater coolant are discharged.

9. The system of claim 8 wherein said combined freshwater and freshwater coolant is treated to improve its quality.

10. A system for reducing wastewater and generating freshwater comprising:
a wastewater evaporator;
a combustion gas contactor;
a first heat exchanger wherein (i) said first heat exchanger transfers heat from a combustion gas within said combustion gas contactor to a wastewater within said wastewater evaporator and (ii) said heat transfer with said first heat exchanger cools said combustion gas to a temperature above the temperature at which freshwater begins to condense from said combustion gas; and
a second heat exchanger wherein (a) said second heat exchanger further transfers heat from said combustion gas within said combustion gas contactor to said wastewater within said wastewater evaporator and (b) said heat transfer with said second heat exchanger cools said combustion gas to a temperature below the temperature at which freshwater begins to condense from said combustion gas.

11. The system of claim 10 wherein said heat transfer with said first heat exchanger and said heat transfer with said second heat exchanger assists at least partial evaporation of said wastewater within said wastewater evaporator.

12. The system of claim 10 wherein said cooling with said second heat exchanger condenses freshwater from said combustion gas and said combustion gas contactor discharges said freshwater.

13. The system of claim 10 wherein said heat transfer with said first heat exchanger involves circulating a coolant between said first heat exchanger and said combustion gas contactor.

14. The system of claim 11 wherein said at least partial evaporation of said wastewater reduces the volume of said wastewater within said wastewater evaporator.

15. The system of claim 11 wherein said wastewater evaporator discharges a reduced liquid generated by said at least partial evaporation of said wastewater.

16. The system of claim 11 wherein said wastewater evaporator discharges a solid material generated by said at least partial evaporation of said wastewater.

17. The system of claim 10 wherein a freshwater coolant circulates between said second heat exchanger and said combustion gas contactor, wherein said cooling condenses freshwater from said combustion gas, wherein said freshwater combines with said freshwater coolant, and excess volumes of said combined freshwater and freshwater coolant are discharged.

18. The system of claim 17 wherein said combined freshwater and freshwater coolant is treated to improve its quality.

19. A method for reducing wastewater and generating freshwater comprising: transferring heat from a combustion gas to a wastewater wherein said transferring cools said combustion gas to a temperature below the temperature at which freshwater begins to condense from said combustion gas and wherein said transferring assists at least partial evaporation of said wastewater.

20. The method of claim 19 wherein said cooling condenses freshwater from said combustion gas and said freshwater is discharged.

21. The method of claim 19 wherein said transferring heat from a combustion gas involves circulating a coolant.

22. The method of claim 19 wherein said at least partial evaporation of said wastewater reduces the volume of said wastewater.

23. The method of claim 19 further comprising discharging a reduced liquid generated by said at least partial evaporation of said wastewater.

24. The method of claim 19 further comprising discharging a solid material generated by said at least partial evaporation of said wastewater.

25. The method of claim 19 wherein said transferring heat from a combustion gas involves circulating a freshwater coolant, wherein said cooling condenses freshwater from said combustion gas, wherein said freshwater combines with said freshwater coolant, and excess volumes of said combined freshwater and freshwater coolant are discharged.

26. The method of claim 25 further comprising treating said combined freshwater and freshwater coolant to improve its quality.

27. A method for reducing wastewater and generating freshwater comprising: firstly transferring heat from a combustion gas to a wastewater wherein said firstly transferring heat cools said combustion gas to a temperature above the temperature at which freshwater first begins to condense from said combustion gas; secondly transferring heat from said combustion gas to said wastewater wherein said secondly transferring heat cools said combustion gas to a temperature below the temperature at which freshwater begins to condense from said combustion gas; and evaporating at least a portion of said wastewater with said firstly transferring heat and with said secondly transferring heat.

28. The method of claim 27 wherein said secondly transferring heat condenses freshwater from said combustion gas and said condensed freshwater is discharged.

29. The method of claim 27 wherein said firstly transferring heat involves circulating a coolant.

30. The method of claim 27 wherein said evaporating at least a portion of said wastewater reduces the volume of said wastewater.

31. The method of claim 27 further comprising discharging a reduced liquid generated by said evaporating at least a portion of said wastewater.

32. The method of claim 27 further comprising discharging a solid material generated from said evaporating of at least a portion of said wastewater.

33. The method of claim 27 wherein said secondly transferring heat from a combustion gas involves circulating a freshwater coolant, wherein said secondly transferring heat condenses freshwater from said combustion gas, wherein said freshwater combines with said freshwater coolant, and excess volumes of said combined freshwater and freshwater coolant are discharged.

34. The method of claim 33 further comprising treating said combined freshwater and freshwater coolant to improve its quality.
